(19) United States
(12) Patent Application Publication
(10) Pub. No.: US 2026/0034627 A1
(43) Pub. Date: Feb. 5, 2026

(54) TRANSFER APPARATUS AND METHOD OF TRANSFERRING TARGET OBJECT USING THE SAME

(71) Applicant: Samsung Display Co., LTD., Yongin-si (KR)

(72) Inventor: Jun Hak OH, Yongin-si (KR)

(73) Assignee: Samsung Display Co., LTD., Yongin-si (KR)

(21) Appl. No.: 19/183,144

(22) Filed: Apr. 18, 2025

(30) Foreign Application Priority Data
Aug. 5, 2024 (KR) 10-2024-0103840

(51) Int. Cl. B23Q 7/00; B23Q 7/14

(52) U.S. Cl. CPC B23Q 7/005; B23Q 7/14

(57) ABSTRACT

A transfer apparatus for transferring a target object includes a transfer stage including a lift stage that is vertically movable and a jig which is disposed on the lift stage and forms a base on which a target object is disposed, and a mask replaceably disposed on the lift stage.

### CROSS-REFERENCE TO RELATED APPLICATION(S)

This application claims priority to and benefits of Korean Patent Application No. 10-2024-0103840 under 35 U.S.C. § 119, filed on Aug. 5, 2024, in the Korean Intellectual Property Office (KIPO), the entire contents of which are incorporated herein by reference.

### BACKGROUND

### 1. Technical Field

The disclosure generally relates to a transfer apparatus and a method of transferring an object using the same.

### 2. Description of Related Art

Multiple process steps are performed to manufacture an electronic device such as a display device. At least a portion of the process steps are performed in process sections spatially separated from each other. It is necessary to appropriately transfer process target objects between a previous process section and a subsequent process section. For example, it is necessary to thoroughly fix target objects to a transfer stage such that the target objects are not damaged in a transfer process between process sections.

### SUMMARY

Embodiments provide a transfer apparatus and a method of transferring a target object using the same, in which process cost is reduced and process convenience is improved.

Embodiments also provide a transfer apparatus and a method of transferring a target object using the same, in which a transfer target object is thoroughly fixed, so that physical influence during transferring can be reduced.

In accordance with an embodiment of the disclosure, a transfer apparatus for transferring a target object may include a transfer stage including a lift stage that is vertically movable and a jig which is disposed on the lift stage and forms a base on which a target object is disposed, and a mask replaceably disposed on the lift stage.

The transfer stage may form an adaptive coupling structure according to a size of the target object.

The lift stage may be moved adjacent to the jig such that a size of a mask accommodation space between the lift stage and the jig is decreased.

The lift stage may include a base which has a flat surface and faces a lower surface of the jig.

The transfer apparatus may further include a base member forming a lower portion and a side portion of the transfer stage.

The base member may include a base opening. A width of the base opening may be greater than a thickness of the mask in a thickness direction of the mask such that the mask may be input and extracted through the base opening.

The mask may not be physically and chemically coupled to an upper surface of the lift stage at a moment that the mask is placed on the lift stage.

The transfer apparatus may further include a moving member that moves the lift stage and is disposed in an area surrounded by the base member.

The transfer apparatus may further include a vacuum forming portion formed at a periphery of the base member and including a vacuum pump.

The jig may include a plurality of jig openings.

In case that the mask is disposed on the lift stage, at least a portion of the plurality of jig openings and a mask opening of the mask may overlap each other in a plan view.

The target object may be a display panel or a polarizing film.

The transfer apparatus may move the target object through a rail formed between process sections.

In accordance with an embodiment of the disclosure, a transfer method may include providing a mask on a lift stage in a transfer stage; adjusting a height of the lift stage; and disposing a target object on a jig disposed on the transfer stage.

The transfer stage may be disposed on a rail and a support member, and the target object may be closely adhered to the jig.

The providing of the mask may include providing the mask through a base opening formed in a base member accommodating the lift stage therein. Before the adjusting of the height of the lift stage, the lift stage may be disposed lower than the base opening.

The mask may include a mask opening. The jig may include a jig opening. The providing of the mask may include disposing the mask on the lift stage such that the mask opening and the jig opening overlap each other in a plan view.

The adjusting of the height may include moving the lift stage until an upper surface of the mask is adjacent to a lower surface of the jig.

The disposing of the target object may include sucking air through the mask opening and the jig opening, and closely adhering the target object to an upper surface of the jig.

The providing of the mask may include replaceably disposing the mask on an upper surface of the lift stage.

### BRIEF DESCRIPTION OF THE DRAWINGS

Embodiments will now be described more fully hereinafter with reference to the accompanying drawings; however, they may be embodied in different forms and should not be construed as limited to the embodiments set forth herein. Rather, these embodiments are provided so that this disclosure will be more thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIGS. 1 and 2 are schematic diagrams illustrating a transfer stage in accordance with an embodiment of the disclosure.

FIG. 3 is a schematic cross-sectional view illustrating a transfer apparatus including a transfer stage and a mask in accordance with an embodiment of the disclosure.

FIG. 4 is a schematic plan view illustrating a mask in accordance with an embodiment of the disclosure.

FIG. 5 is a schematic plan view illustrating a jig in accordance with an embodiment of the disclosure.

FIGS. 6 to 11 are schematic views illustrating process steps of a transfer method using the transfer apparatus in accordance with an embodiment of the disclosure.

### DETAILED DESCRIPTION OF THE EMBODIMENTS

The disclosure may apply various changes and different shape, therefore only illustrate in details with particular embodiments. However, the embodiments do not limit to certain shapes but apply to all the change and equivalent material and replacement. The drawings included illustrate a fashion where the figures are expanded for the better understanding.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Also, when an element is referred to as being “in contact” or “contacted” or the like to another element, the element may be in “electrical contact” or in “physical contact” with another element; or in “indirect contact” or in “direct contact” with another element.

It will be understood that, although the terms “first”, “second”, etc. may be used herein to describe various elements, these elements should not be limited by these terms. These terms are only used to distinguish one element from another element. Thus, a “first” element discussed below could also be termed a “second” element without departing from the teachings of the disclosure. As used herein, the singular forms are intended to include the plural forms as well, unless the context clearly indicates otherwise.

It will be further understood that the terms “includes” and/or “including”, when used in this specification, specify the presence of stated features, integers, steps, operations, elements, and/or components, but do not preclude the presence and/or addition of one or more other features, integers, steps, operations, elements, components, and/or groups thereof.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

In the specification and the claims, the phrase “at least one of” is intended to include the meaning of “at least one selected from the group of” for the purpose of its meaning and interpretation. For example, “at least one of A and B” may be understood to mean “A, B, or A and B.” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

The disclosure generally relates to a transfer apparatus and a method of transferring a target object using the same. Hereinafter, a transfer apparatus and a method of transferring a target object using the same in accordance with an embodiment of the disclosure will be described with reference to the accompanying drawings.

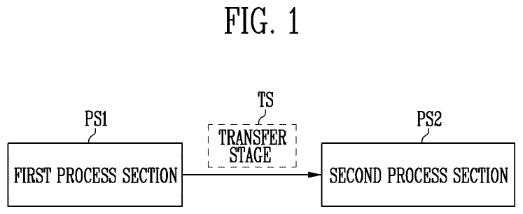

A transfer apparatus in accordance with embodiments of the disclosure will be described with reference to FIGS. 1 to 5.

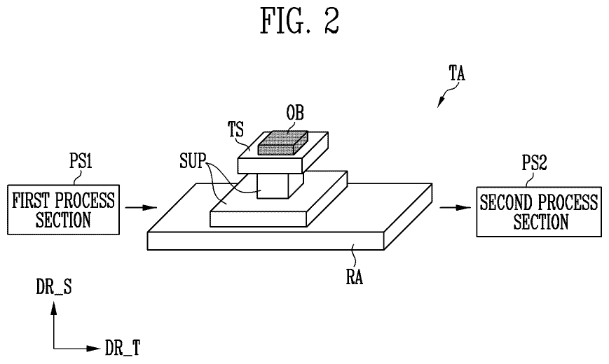

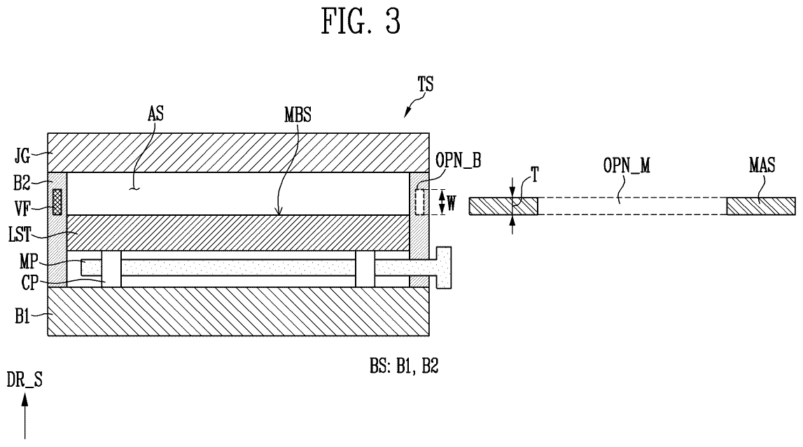

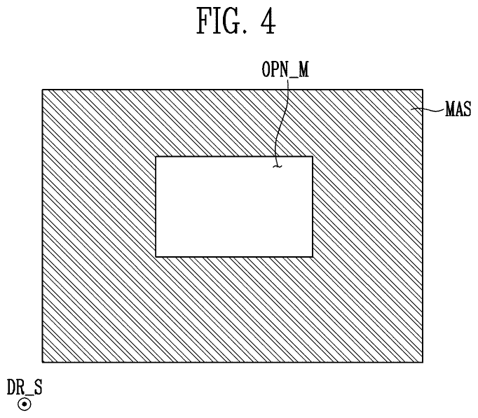

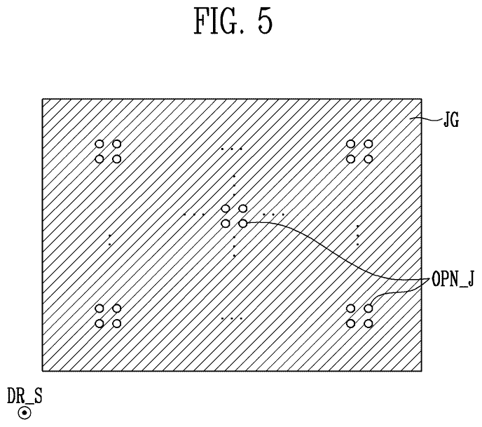

FIGS. 1 and 2 are schematic diagrams illustrating a transfer stage in accordance with an embodiment of the disclosure. FIG. 3 is a schematic cross-sectional view illustrating a transfer apparatus including a transfer stage and a mask in accordance with an embodiment of the disclosure. FIG. 4 is a schematic plan view illustrating a mask in accordance with an embodiment of the disclosure. FIG. 5 is a schematic plan view illustrating a jig in accordance with an embodiment of the disclosure.

Referring to FIGS. 1 to 5, a transfer apparatus TA in accordance with an embodiment of the disclosure may be configured to transfer a target object OB between process sections PS1 and PS2 disposed at different positions. In some embodiments, the transfer apparatus TA may move the target object OB along a transfer direction DR T.

For example, a rail RA may be formed between a first process section PS1 in which a first process is performed within a first time interval and a second process section PS2 in which a second process is performed within a second time interval posterior to the first time interval. The transfer apparatus TA may be movable from the first process section PS1 to the second process section PS2 through the rail RA.

The target object OB may be various objects transferrable by the transfer apparatus TA. For example, the target object OB may be a display panel provided in a manufacturing process of a display device. In another embodiment, the target object OB may be a polarizing film. However, the disclosure is not limited to a specific example.

In some embodiments, the transfer apparatus TA may include a transfer stage TS.

The transfer stage TS may have a base (e.g., a top surface) on which the target object OB may be disposed. The transfer stage TS may be disposed on a support member SUP disposed on the rail RA. Accordingly, the target object OB may be disposed on the top surface of the transfer stage TS and movable from the first process section PS1 to the second process section PS2.

In some embodiments, the transfer apparatus TA may include the support member SUP.

In case that the transfer stage ST is movable between the first and second process sections PS1 and PS2, the support member SUP may be disposed on the rail RA and form a base on which the transfer stage TS may be disposed. The support member SUP may generally extend in a stacked direction DR_S. A lower portion of the support member SUP may have a wide area in a plan view, and accordingly, the support member SUP may support the transfer stage TS to be stably movable on the rail RA.

In some embodiments, the transfer apparatus TA may include a mask MAS replaceably disposed on at least a portion of the transfer stage TS.

In some embodiments, the transfer stage TS may include a base member BS, a moving member MP, a connection portion CP, a lift stage LST, a vacuum forming portion VF, and a jig JG.

The base member BS may form an outer surface of the transfer stage TS, and stably support middle and lower portions of the transfer stage TS. The base member BS may include a relatively rigid material.

The base member BS may include a first base portion B1 and a second base portion B2. The first base portion B1 may be a lower plate, and the second base portion B2 may be a middle plate. The first base portion B1 may form a lower portion of the transfer stage TS. The second base portion B2 may form a side portion of the transfer stage TS. However, the disclosure is not limited thereto. In another embodiment, the first base portion B1 and the second base portion B2 may be integral with each other.

The moving member MP may be disposed on the first base portion B1. The moving member MP may be disposed between the first base portion B1 and the lift stage LST. The moving member MP may extend in a direction, and a portion of the moving member MP may extend over the second base portion B2.

The connection portion CP may be disposed between the first base portion B1 and the lift stage LST. The connection portion CP may be connected to a lower surface of the lift stage LST, and be connected to the moving member MP.

The moving member MP may be configured to vertically move the lift stage LST through the connection portion CP. The manner in which the moving member MP moves the lift stage LST is not limited to a specific embodiment. For example, the connection portion CP may be configured to rotate about an axial direction of the moving member MP, so that the connection portion CP may pull or push the lift stage LST according to rotation of the moving member MP. Accordingly, the lift stage LST may be vertically movable. In another embodiments, the moving member MP may be implemented in various manners such as a motor and a hydraulic system. In some embodiments, an operation of the moving member MP may be implemented in an automatic or manual manner, but the disclosure is not limited to a specific example.

The lift stage LST may be disposed in an area surrounded by the base member BS. The lift stage LST may be disposed between the moving member MP and the jig JG. The lift stage LST may be adjacent to the second base portion B2.

The lift stage LST may be configured to be vertically movable. For example, the lift stage LST may be moved to be adjacent to the jig JG, and be moved to be spaced apart from the jig JG.

As the lift stage LST is vertically movable, a mask accommodation space AS between the lift stage LST and the jig JG may be increased or decreased. The mask accommodation space AS may be an area surrounded by an upper surface of the lift stage LST and a lower surface of the jig JG.

The lift stage LST may have an upper surface extending along a plane, and form a base MBS on which the mask MAS may be disposed. The base MBS may face a lower surface of the jig JG. The base MBS may have a generally flat surface such that the mask MAS may be stably disposed. The base MBS may face the lower portion of the jig JG.

The lift stage LST may include a fluid flow path (not shown). For example, the fluid flow path may be an opening structure formed in at least a portion of the lift stage LST, and may be fluidly connected to the vacuum forming portion VF as the position of the lift stage LST is adjusted.

The vacuum forming portion VF may be formed at a periphery of the base member BS. The vacuum forming portion VF may keep a mask opening OPN_M of the mask MAS disposed in the mask accommodation space AS in a vacuum state. For example, the vacuum forming portion VF may be implemented in various manners such as a vacuum pump. However, the disclosure is not limited to a specific embodiment.

In some embodiments, the transfer stage TS may include a base opening OPN_B.

The base opening OPN_B may be formed at a side portion of the transfer stage TS. The base opening OPN_B may be formed in a portion of the base member BS (e.g., the second base portion B2). The base opening OPN_B may be an area through which the mask MAS may be input or extracted.

A size of the base opening OPN_B may be greater than or equal to a size with which the mask MAS can be input. For example, a width W of the base opening OPN_B may be greater than a thickness T of the mask MAS in the stacked direction DR S.

The mask MAS may be placed into the mask accommodation space AS. The mask MAS may be replaceably disposed in the transfer stage TS. The mask MAS may be replaceably disposed on the base MBS of the lift stage LST. The mask MAS may not be physically and chemically coupled in the mask accommodation space AS. The mask MAS may not be physically and chemically coupled to the upper surface of the lift stage LST. For example, the mask MAS may be physically and chemically separated from the lift stage LST.

The mask MAS may be input through the base opening OPN_B, and be extracted through the base opening OPN_B.

The mask MAS may include the mask opening OPN_M corresponding to a size of the target object OB. For example, the mask opening OPN_M may have a size corresponding to the size of the target object OB in a plan view. The shape of the mask opening OPN_M is not limited to a specific embodiment. The shape of the mask opening OPN_M may be identical to the shape of the target object OB to be transferred.

The mask MAS may include at least one of a urethane resin, a PEEK resin, and aluminum. In case that the transfer stage TS includes a vacuum structure for closely adhering the target object OB to the jig JG, a risk that air is leaked through the periphery of the mask MAS may be reduced, and the transfer apparatus TA may be further lightened.

The jig JG may be disposed on the lift stage LST. The jig JG may be disposed on the base member BS. Lower edges of the jig JG may be coupled to the second base portion B2.

The jig JG may be formed on the transfer stage LST, and form a base on which the target object OB may be disposed. An upper surface of the jig JG may be exposed. The jig JG may include a jig opening OPN_J. The jig opening OPN_J may include multiple jig openings. In case that the vacuum forming portion VF induces the lower portion of the jig JG to be in a vacuum state (e.g., in case that the vacuum forming portion VF sucks air), the jig opening OPN_J may support and fix (or closely adhere) the target object OB disposed on the jig opening OPN_J to the upper surface of the jig JG.

In some embodiments, the mask MAS having the mask opening OPN_M corresponding to the size of the target object OB may be replaceably disposed in the transfer stage TS. Target objects OB may be fixed to the transfer stage TS without separately replacing the jig JG according to types of the target objects OB.

Accordingly, the transfer stage TS in accordance with an embodiment of the disclosure may form an adaptive coupling structure to support different target objects OB. The transfer stage TS may form an adaptive coupling structure according to the size of the target object OB. For example, a first target object may be disposed on the jig JG to transfer the first target object, and a first mask may be used. A second target object may be disposed on a same jig JG to transfer the second target object, and a second mask may be used. As a result, replacement of the jig JG may not be made corresponding to different target objects OB. Accordingly, process cost may be reduced, and process convenience may be improved.

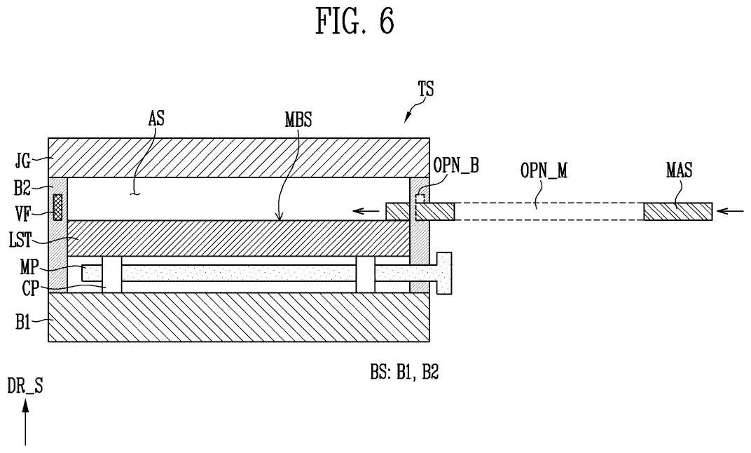

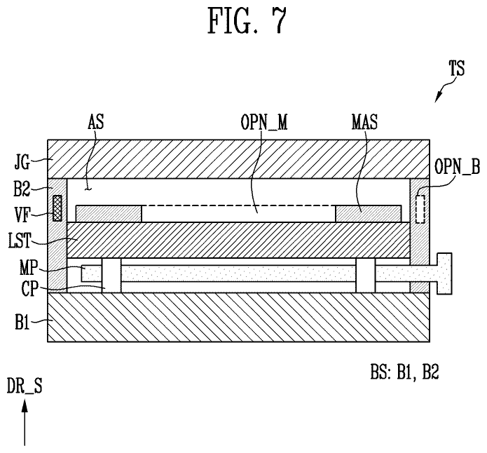

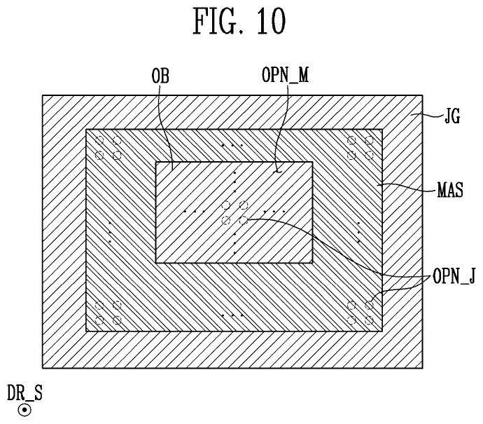

Hereinafter, a method of transferring a target object OB, using the transfer apparatus TA, in accordance with an embodiment of the disclosure will be described with reference to FIGS. 6 to 11. For convenience of description, descriptions of portions overlapping with the above-described portions will be simplified or will not be repeated.

FIGS. 6 to 11 are schematic views illustrating process steps of a transfer method using the transfer apparatus in accordance with an embodiment of the disclosure.

Referring to FIGS. 6, 7, and 10, the transfer stage TS and the mask MAS including the mask opening OPN_M having a size corresponding to a size of a target object OB may be provided. The mask MAS may be input on the base MBS of the lift stage LST in the mask accommodation space AS through the base opening OPN_B.

In this step, the lift stage LST may be disposed at a relatively low portion. The lift stage LST may be disposed at a first position. The lift stage LST may be disposed lower than the base opening OPN_B with respect to the stacked direction DR_S. Accordingly, the mask MAS provided through the base opening OPN_B may be appropriately placed on the base MBS of the lift stage LST.

In this step, the mask MAS may be disposed on the lift stage LST such that the mask opening OPN_M overlaps at least a portion of the jig openings OPN_J of the jig JG in a plan view. In this step, at least a portion of the mask accommodation space AS above the mask MAS may not be filled.

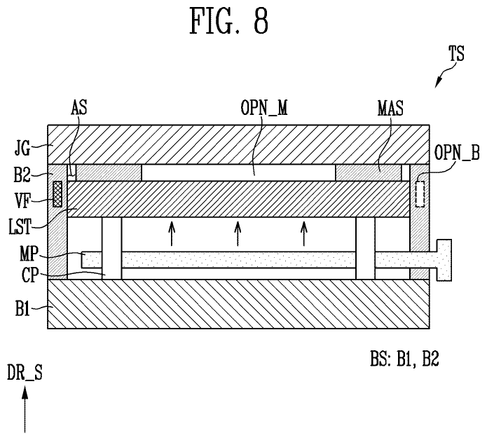

Referring to FIG. 8, the lift stage LST may be moved adjacent to the jig JG, and accordingly, the mask MAS may be adjacent to the lower surface of the jig JG.

In this step, the height of the lift stage LST may be adjusted. For example, the moving member MP may move the lift stage LST in an upper direction. The lift stage LST may be disposed at a relatively upper position. The lift stage LST may be disposed at a second position. In some embodiments, the lift stage LST may be moved upwardly until an upper surface of the mask MAS is directly adjacent to the lower portion of the jig JG. In some embodiments, the mask opening OPN_M may be directly adjacent to the lower surface of the jig JG. In this step, the mask accommodation space AS may be reduced.

In this step, the mask opening OPN_M may be adjacent to the jig JG, and accordingly, at least a portion of the jig openings OPN_J and the mask opening OPN_M may overlap each other in the stacked direction DR S.

In this step, a side portion of the lift stage LST may be adjacent to the vacuum forming portion VF. For example, the position of the lift stage LST in the stacked direction DR_S may be changed, and the side portion of the lift stage LST may be disposed to be adjacent to the vacuum forming portion VF.

The vacuum forming portion VF may be fluidly connected to the fluid flow path of the lift stage LST. In some embodiments, the fluid flow path of the lift stage LST may be fluidly connected to at least a portion of the mask opening OPN_M. Accordingly, the mask opening OPN_M may be fluidly connected to the vacuum forming portion VF through at least a portion of the lift stage LST. As described above, since at least a portion of the jig openings OPN_J and the mask opening OPN_M overlap each other, the jig openings OPN_J, the mask opening OPN_M, the lift stage LST, and the vacuum forming portion VF may be fluidly connected to each other.

In this specification, a fluidly connected structure may mean a structure having a path through which a fluid such as air may flow without being generally interrupted.

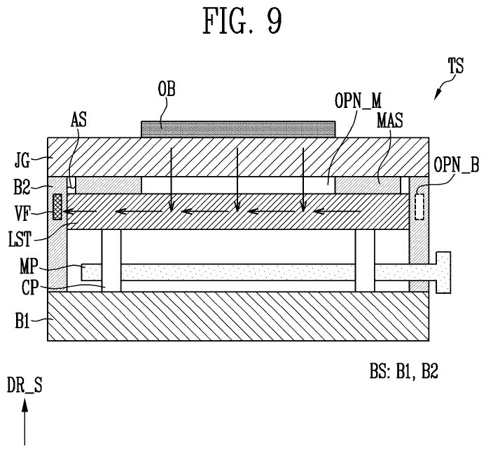

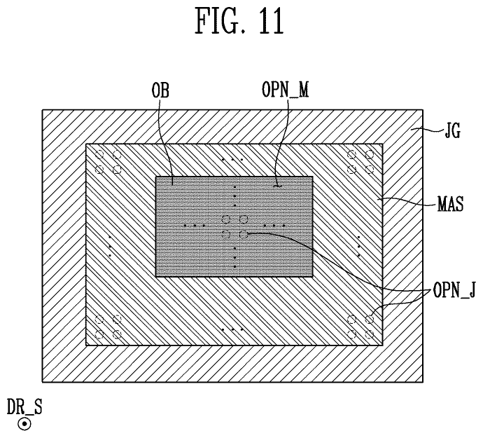

Referring to FIGS. 9 and 11, the target object OB may be placed on the jig JG, and be adhered closely to the upper surface of the jig JG by the vacuum forming portion VF.

In this step, the target object OB may be placed on the upper surface of the jig JG to correspond to the position of the mask opening OPN_M in a plan view.

In this step, the vacuum forming portion VF may suck air through the jig opening OPN_J, the mask opening OPN_M, and a portion of the lift stage LST. Accordingly, an area directly below at least a portion of the target object OB may be in a vacuum state, and the target object OB may be adhered closely to the upper surface of the jig JG. Accordingly, the target object OB is firmly fixed to the transfer stage ST, and stably moved between process sections PS1 and PS2.

After the target object OB is fixed on the jig JG as this step is performed, the transfer apparatus TA may be transferred to an intended position along a route.

In accordance with an embodiment of the disclosure, the target object OB may be fixed to the transfer stage TS without replacement of the jig JG, using a mask MAS provided for the target object OB. Accordingly, process cost may be reduced, and process convenience may be improved.

Further, since the size of the mask opening OPN_M is formed according to the size of the target object OB, and an operation of the lift stage LST is performed based on a vacuum forming structure for closely adhering the target object OB to the jig JG, the target object OB may be firmly fixed on the jig JG. Accordingly, the structural stability of the target object OB during transferring may be ensured, and influence caused by external factors (e.g., a physical element and the like) may be reduced.

In accordance with the disclosure, there may be provided a transfer apparatus and a method of transferring a target object using the same, in which process cost is reduced and process convenience is improved.

In accordance with the disclosure, there may be provided a transfer apparatus and a method of transferring a target object using the same, in which a transfer target object is firmly fixed, so that physical influence during transferring may be reduced.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A transfer apparatus for transferring a target object, the transfer apparatus comprising:
a transfer stage including a lift stage that is vertically movable and a jig which is disposed on the lift stage and forms a base on which a target object is disposed; and
a mask replaceably disposed on the lift stage.

2. The transfer apparatus of claim 1, wherein the transfer stage forms an adaptive coupling structure according to a size of the target object.

3. The transfer apparatus of claim 1, wherein the lift stage is moved adjacent to the jig such that a size of a mask accommodation space between the lift stage and the jig is decreased.

4. The transfer apparatus of claim 3, wherein the lift stage includes a base which has a flat surface and faces a lower surface of the jig.

5. The transfer apparatus of claim 1, further comprising:
a base member forming a lower portion and a side portion of the transfer stage.

6. The transfer apparatus of claim 5, wherein
the base member includes a base opening, and
a width of the base opening is greater than a thickness of the mask in a thickness direction of the mask such that the mask is input and extracted through the base opening.

7. The transfer apparatus of claim 5, wherein the mask is not physically and chemically coupled to an upper surface of the lift stage at a moment that the mask is placed on the lift stage.

8. The transfer apparatus of claim 7, further comprising:
a moving member that moves the lift stage and is disposed in an area surrounded by the base member.

9. The transfer apparatus of claim 5, further comprising:
a vacuum forming portion formed at a periphery of the base member and including a vacuum pump.

10. The transfer apparatus of claim 9, wherein the jig includes a plurality of jig openings.

11. The transfer apparatus of claim 10, wherein, in case that the mask is disposed on the lift stage, at least a portion of the plurality of jig openings and a mask opening of the mask overlap each other in a plan view.

12. The transfer apparatus of claim 1, wherein the target object is a display panel or a polarizing film.

13. The transfer apparatus of claim 1, wherein the transfer apparatus moves the target object through a rail formed between process sections.

14. A transfer method comprising:
providing a mask on a lift stage in a transfer stage;
adjusting a height of the lift stage; and
disposing a target object on a jig disposed on the transfer stage.

15. The transfer method of claim 14, wherein
the transfer stage is disposed on a rail and a support member, and
the target object is closely adhered to the jig.

16. The transfer method of claim 14, wherein
the providing of the mask includes providing the mask through a base opening formed in a base member accommodating the lift stage therein, and
before the adjusting of the height of the lift stage, the lift stage is disposed lower than the base opening.

17. The transfer method of claim 16, wherein
the mask includes a mask opening,
the jig includes a jig opening, and
the providing of the mask includes disposing the mask on the lift stage such that the mask opening and the jig opening overlap each other in a plan view.

18. The transfer method of claim 17, wherein the adjusting of the height includes moving the lift stage until an upper surface of the mask is adjacent to a lower surface of the jig.

19. The transfer method of claim 18, wherein the disposing of the target object includes sucking air through the mask opening and the jig opening, and closely adhering the target object to an upper surface of the jig.

20. The transfer method of claim 19, wherein the providing of the mask includes replaceably disposing the mask on an upper surface of the lift stage.
